(19) United States
(12) Patent Application Publication
(10) Pub. No.: US 2011/0050856 A1
(43) Pub. Date: Mar. 3, 2011

(54) STEREOSCOPIC IMAGING APPARATUS

(75) Inventors: Michitaka NAKAZAWA, Saitama-shi (JP); Atsushi MISAWA, Saitama-shi (JP)

(73) Assignee: FUJIFILM CORPORATION, Tokyo (JP)

(21) Appl. No.: 12/870,735

(22) Filed: Aug. 27, 2010

(30) Foreign Application Priority Data
Aug. 28, 2009 (JP) 2009-198482

(51) Int. Cl. H04N 13/02

(52) U.S. Cl. 348/47; 348/E13.074

(57) ABSTRACT

A stereoscopic imaging apparatus includes: a first and second imaging units, each of which has a substantially rectangular shape, and each of which has a thick section and a thin section that are arranged side by side; and a camera body which has a substantially rectangular shape, and in which the first and second imaging units are arranged side by side in a lateral direction of the camera body, wherein the first and second imaging units are arranged so that the thin section of the first imaging unit is positioned at an outer side of the camera body and so that the thick section of the second imaging unit is positioned at the outer side, the first imaging unit is arranged in parallel with the lateral direction, and the second imaging unit is arranged so as to be inclined inward by a predetermined angle with respect to the lateral direction.

### BACKGROUND OF THE INVENTION

1. Field of the Invention

The presently disclosed subject matter relates to a stereoscopic imaging apparatus, and more particularly to a stereoscopic imaging apparatus, a body of which can be made thinner

2. Description of the Related Art

A compound-eye camera including two imaging units to obtain two images having parallax, is known. In order to obtain an image having a stereoscopic effect at a finite distance, the two cameras need to be arranged so that the optical axes of the cameras form a convergence angle by being directed to about the middle of the photographing distance range (from the infinity to the closest distance) of the cameras.

Japanese Patent Application Laid-Open No. 2006-91177 discloses a stereoscopic camera that can precisely adjust positions of two imaging sections of a first imaging section and a second imaging section, with a simple configuration using a stay consisting of: a fixing section to which the first imaging section is fixed; an adjusting section to which the second imaging section is attached and which is provided with an adjusting mechanism for adjusting the rotational positions about the pitch, the yaw and the roll axes of the second imaging section; and a base section which integrally couples the fixing section and the adjusting section while leaving a predetermined interval between the fixing section and the adjusting section.

Japanese Patent Application Laid-Open No. 2003-84357 discloses a mounting structure of a large-sized stereoscopic camera, which structure prevents deformation of a rectangular base plate by being configured such that cameras are attached to both ends of the base plate, such that brackets made of a plastic member are attached to both the ends of the base plate, and such that the tip shafts of the brackets are respectively fixed to posts, and which structure can thereby solve a problem of optical axis deviation due to the deformation of the cameras that is caused under the influence of the surface precision of the attachment surface at the time of attachment of the cameras.

Japanese Patent Application Laid-Open No. 2008-129439 discloses a compound-eye imaging apparatus configured such that a certain number of imaging units are detachably attached to a camera main body so that a suitable baseline length corresponding to a distance to a subject can be freely selected.

### SUMMARY OF THE INVENTION

However, in Japanese Patent Application Laid-Open Nos. 2006-91177, 2003-84357 and 2008-129439, only the configuration (arrangement) for attaching the imaging unit to the base plate (the stay, the base, the main body) is disclosed. The reduction in the thickness of the camera is not taken into consideration, in Japanese Patent Application Laid-Open Nos. 2006-91177, 2003-84357 and 2008-129439.

The presently disclosed subject matter has been made in view of the above described circumstances. An object of the presently disclosed subject matter is to provide a stereoscopic imaging apparatus, a body of which can be made thinner by suitably arranging and attaching a plurality of imaging units.

In order to achieve the above described object, a first aspect of the presently disclosed subject matter provides a stereoscopic imaging apparatus including: a first and second imaging units, each of which has a substantially rectangular shape when viewed from above, and each of which has a thick section and a thin section that are arranged side by side; and a camera body which has a substantially rectangular shape when viewed from above, and in which the first and second imaging units are arranged side by side in a lateral direction of the camera body, wherein the first and second imaging units are arranged in the camera body so that the thin section of the first imaging unit is positioned at an outer side of the camera body and so that the thick section of the second imaging unit is positioned at the outer side of the camera body, wherein the first imaging unit is arranged in parallel with the lateral direction of the camera body, and wherein the second imaging unit is arranged so as to be inclined inward by a predetermined angle with respect to the lateral direction of the camera body.

In the stereoscopic imaging apparatus according to the first aspect, the thick section and the thin section of the imaging units are laterally arranged side by side in the camera body which has a substantially rectangular shape when viewed from the above. Further, the two imaging units, each of which has a substantially rectangular shape when viewed from the above, are arranged side by side in the lateral direction. The first imaging unit, which is the imaging unit having the thin section positioned at the outer side, is arranged in parallel with the camera body, while the second imaging unit, which is the imaging unit having the thick section positioned at the outer side, is arranged so as to be inclined inward by the predetermined angle with respect to the camera body. Thereby, the two imaging units can be arranged so that the optical axes of the two imaging units cross each other at the predetermined angle (convergence angle). Further, the imaging unit having the thick section positioned at the outer side is arranged so as to be inclined with respect to the camera body, whereby the camera body, that is, the compound-eye imaging apparatus can be made thin.

A second aspect of the presently disclosed subject matter provides a stereoscopic imaging apparatus according to the first aspect, further including: a connecting member which connects the first and second imaging units to each other; and an attaching member which attaches the second imaging unit to the connecting member, wherein the attaching member is arranged in a space formed between the second imaging unit and the camera body.

In the stereoscopic imaging apparatus according to the second aspect, the second imaging unit and the connecting member are attached to each other by the attaching member in the space formed between the second imaging unit and the camera body. Thereby, the space formed between the second imaging unit and the camera body can be effectively used, which contributes to the reduction in the thickness of the camera body, that is, the compound-eye imaging apparatus.

A third aspect of the presently disclosed subject matter provides a stereoscopic imaging apparatus according to the second aspect, wherein the second imaging unit is arranged in a space formed between the front surface of the second imaging unit and the camera body.

In the stereoscopic imaging apparatus according to the third aspect, the second imaging unit is inclined inward by the predetermined angle with respect to the camera body, and hence the space is formed between the front surface of the second imaging unit and the front surface of the camera body. The effective use of this space can contribute to the reduction in the thickness of the camera body.

A fourth aspect of the presently disclosed subject matter provides a stereoscopic imaging apparatus according to the second aspect, wherein the second imaging unit is arranged in a space formed between the rear surface of the thin section of the second imaging unit and the rear surface of the camera body.

In the stereoscopic imaging apparatus according to the fourth aspect, the second imaging unit has the thin section, and hence the space is formed between the rear surface of the thin section of the second imaging unit and the rear surface of the camera body. The effective use of this space can contribute to the reduction in the thickness of the camera body, that is, the compound-eye imaging apparatus.

A fifth aspect of the presently disclosed subject matter provides a stereoscopic imaging apparatus including: a first and second imaging units, each of which has a substantially rectangular shape when viewed from above; a camera body, on a front surface of which a projecting section is formed, which has a substantially rectangular shape when viewed from above, and in which the first and second imaging units are arranged side by side in a lateral direction of the camera body; and a barrier which is arranged on the front surface of the camera body so as to avoid the projecting section, wherein the first imaging unit is arranged in parallel with the lateral direction of the camera body, and wherein the second imaging unit is arranged on a rear surface of the projecting section so as to be inclined inward by a predetermined angle with respect to the lateral direction of the camera body.

In the stereoscopic imaging apparatus according to the fifth aspect, the projecting section having the height substantially equal to the thickness of the barrier is formed on the front surface of the camera body which has the substantially rectangular shape when viewed from the above, and the two imaging units, each of which has the substantially rectangular shape when viewed from the above, are arranged side by side in the lateral direction in the camera body. The first imaging unit is arranged in parallel with the camera body, while the second imaging unit is arranged so as to be inclined inward by the predetermined angle with respect to the camera body. Thereby, the two imaging units can be arranged so that the optical axes of thereof cross each other at the predetermined angle (convergence angle). Further, the imaging unit, which is arranged so that the thick section thereof is positioned at the outer side, is arranged so as to be inclined with respect to the camera body, and thereby the thickness of the camera body, that is, the compound-eye imaging apparatus can be reduced.

A sixth aspect of the presently disclosed subject matter provides a stereoscopic imaging apparatus according to the fifth aspect, wherein the projecting section has a height substantially equal to the thickness of the barrier. Thereby, the space can be more effectively used.

A seventh aspect of the presently disclosed subject matter provides a stereoscopic imaging apparatus according to any one of the first to sixth aspects, wherein the first and second imaging unit each includes: an imaging element provided on a bottom surface thereof; an opening section formed in the front surface thereof; and a bending optical system which bends subject light entering from the opening section to form an image of the subject light thereon.

In the stereoscopic imaging apparatus according to the seventh aspect, the bending optical system is used in the imaging unit. This can contribute to the reduction in the thickness of the camera body, that is, the compound-eye imaging apparatus.

An eighth aspect of the presently disclosed subject matter provides a stereoscopic imaging apparatus according to any one of the first to seventh aspects, further including: a photographing mode switching device which switches between a stereoscopic image photographing mode for photographing a stereoscopic image by using both the first and second imaging units and a plane image photographing mode for photographing a plane image by using one of the first and second imaging units; and a control device which, when the photographing mode is switched to the plane image photographing mode, performs a photographing operation by using the first imaging unit.

In the stereoscopic imaging apparatus according to the eighth aspect, when the photographing mode is switched to the plane image photographing mode for photographing a plane image by using one of the two imaging units, the photographing operation is performed by using the first imaging unit which is provided in parallel with the camera body. This enables a photographer to photograph the plane image without feeling a sense of incongruity.

According to the presently disclosed subject matter, a body of a stereoscopic imaging apparatus can be made thinner by suitably arranging a plurality of imaging units.

### BRIEF DESCRIPTION OF THE DRAWINGS

FIGS. 1A and 1B are schematic views of a compound-eye digital camera according to a first embodiment of the presently disclosed subject matter, FIG. 1A is a front perspective view thereof, and FIG. 1B is a rear view thereof;

FIGS. 2A and 2B are schematic views of an imaging unit of the compound-eye digital camera of the first embodiment, FIG. 2A is a front perspective view of the imaging unit, and FIG. 2B is a perspective view of a major portion of the imaging unit when viewed from the above;

FIG. 3 is a perspective view of a major portion of the compound-eye digital camera of the first embodiment when viewed from the above;

FIG. 4 is a block diagram illustrating an internal configuration of the compound-eye digital camera of the first embodiment;

FIG. 5 illustrates a modification of the compound-eye digital camera of the first embodiment;

FIG. 6 is a front perspective view of a compound-eye digital camera according to a second embodiment of the presently disclosed subject matter;

FIGS. 7A and 7B are schematic views of an imaging unit of the compound-eye digital camera of the second embodiment, FIG. 7A is a front perspective view of the imaging unit, and FIG. 7B is a perspective view of a major portion of the imaging unit when viewed from the above; and

FIG. 8 is a perspective view of a major portion of the compound-eye digital camera of the second embodiment when viewed from the above.

### DETAILED DESCRIPTION OF THE PREFERRED EMBODIMENTS

In the following, embodiments of a stereoscopic imaging apparatus according to the presently disclosed subject matter will be described with reference to the accompanying drawings.

### First Embodiment

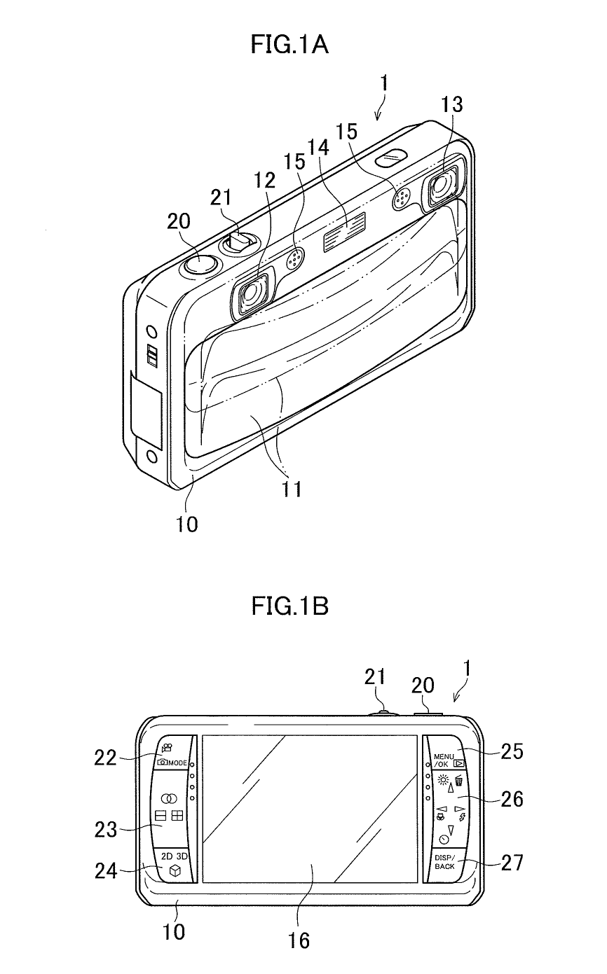

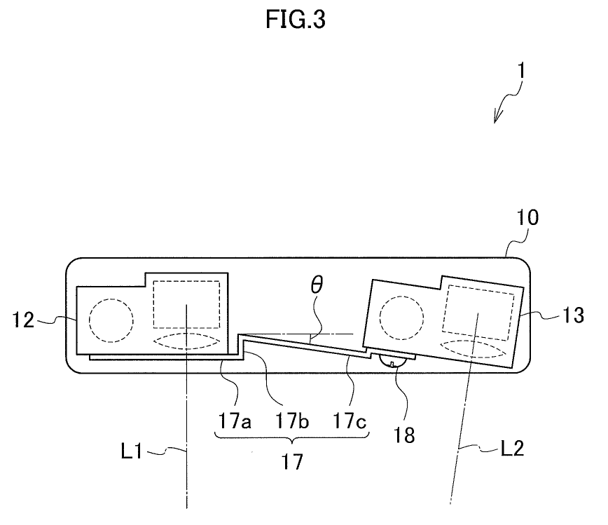

FIG. 1A is a front perspective view of a compound-eye digital camera which is a stereoscopic imaging apparatus according to a first embodiment of the presently disclosed subject matter. FIG. 1B is a rear view of the compound-eye digital camera. FIG. 3 is a perspective view of a major portion of the compound-eye digital camera when viewed from the above. The compound-eye digital camera 1, which includes a plurality of imaging systems (exemplified by two imaging systems in FIG. 1), is capable of photographing a stereoscopic image at the time when the same subject is viewed from a plurality of viewpoints (exemplified by two left and right viewpoints in FIG. 1), and is also capable of photographing a single-viewpoint image (two-dimensional image). Further, the compound-eye digital camera 1 can perform recording and reproduction of not only a still image, but also a moving image as well as sound.

A camera body 10 of the compound-eye digital camera 1 is formed in a substantially rectangular parallelepiped box shape. As illustrated in FIG. 1A, a barrier 11, a right lens unit 12, a left lens unit 13, a flash 14, and microphones 15 are mainly provided on the front surface of the camera body 10. Further, a release switch 20 and a zoom button 21 are mainly provided on the upper surface of the camera body 10.

On the other hand, as illustrated in FIG. 1B, a monitor 16, a mode button 22, a parallax adjusting button 23, a 2D/3D switching button 24, a MENU/OK button 25, a cross button 26, and a D1SP/BACK button 27 are provided on the rear face of the camera body 10.

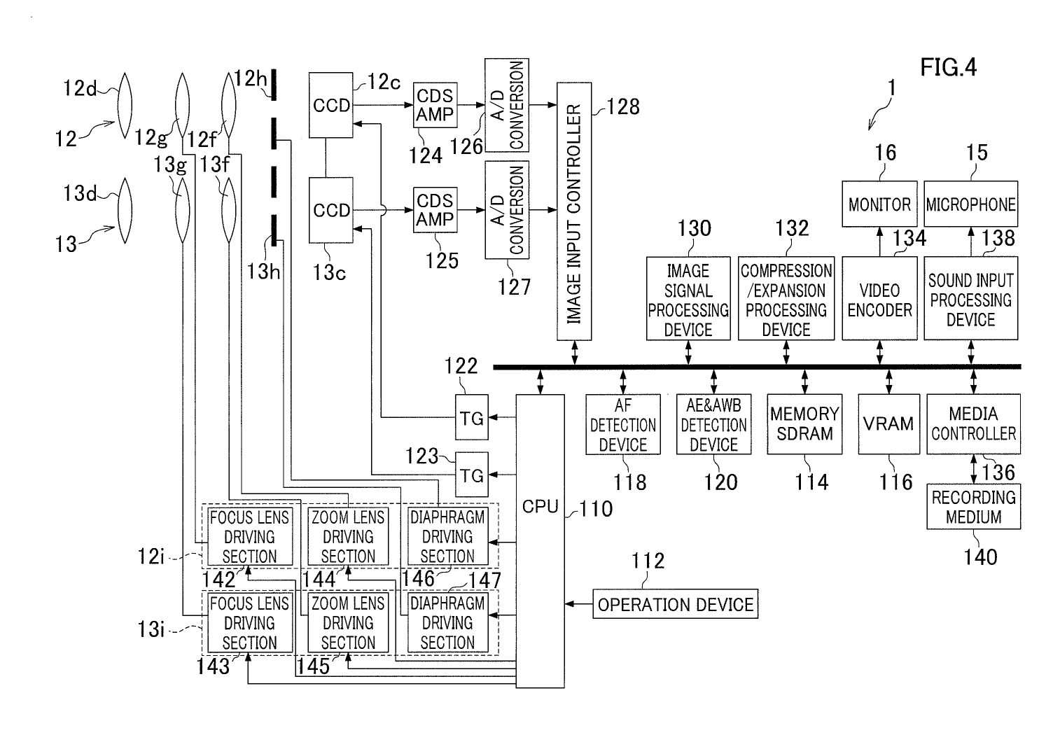

The barrier 11 is slidably mounted on the front surface of the camera body 10, and is vertically slid so as to thereby switch between the opened state and the closed state. Usually, as illustrated by the dotted line (alternate long and two short dashes line) in FIG. 1A, the barrier 11 is positioned at the upper end, that is, held in the closed state, so that the right lens unit 12, the left lens unit 13, and the like, are covered by the barrier 11. Thereby, the lens, and the like, is prevented from being damaged. When the barrier 11 is slid so as to thereby be positioned at the lower end, that is, held in the opened state (see the solid line in FIG. 1A), the lenses, and the like, arranged on the front surface of the camera body are exposed. When the opened state of the barrier 11 is detected by a sensor (not illustrated), a power source is turned on by a CPU (central processing unit) 110 (see FIG. 4) so that photographing is enabled.

The right lens unit 12 for photographing an image for the right eye is an optical unit which includes an opening section 12a, a lens barrel 12b, an imaging element 12c, an objective lens 12d, a photographing lens group having a bending optical system (a prism 12e, a zoom lens 12f (see FIG. 4), a focus lens 12g (see FIG. 4), and the like), and a diaphragm and mechanical shutter 12h (see FIG. 4), and a driving unit 12i. The left lens unit 13 for photographing an image for the left eye is an optical unit which includes an opening section 13a, a lens barrel 13b, an imaging element 13c, an objective lens 13d, a photographing lens group having a bending optical system (a prism 13e, a zoom lens 13f (see FIG. 4), a focus lens 13g (see FIG. 4), and the like), and a diaphragm and mechanical shutter 13h (see FIG. 4), and a driving unit 13i. The right lens unit 12 and the left lens unit 13 have the same configuration, and hence the following description will be given by taking the right lens unit 12 as an example.

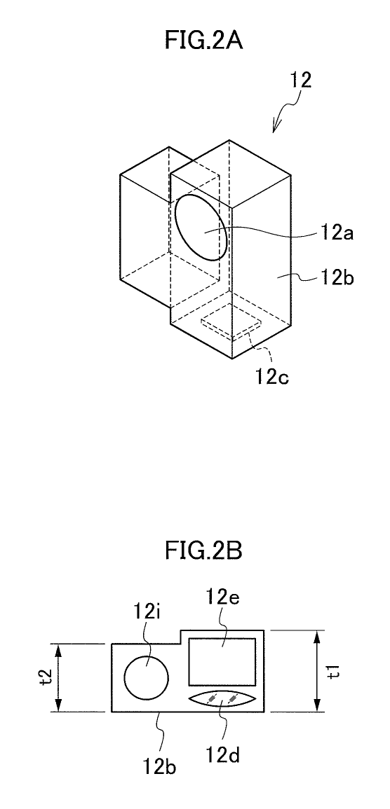

FIG. 2A is a front perspective view of the right lens unit 12, and FIG. 2B is a perspective view of a major portion of the right lens unit 12 when viewed from the above.

The lens barrel 12b, which is a substantially rectangular shaped frame when viewed from the front and above, has, as illustrated in FIG. 2A, cut-outs at the upper and lower corners on the left side when viewed from the front, and has, as illustrated in FIG. 2B, a cut-out at the left back side when viewed from the above. Further, the lens barrel 12b is formed such that the thickness of the right side portion (hereinafter referred to as thick section), which does not have the cut-out when viewed from the above, is t1, and such that the thickness of the left side portion (hereinafter referred to as thin section), which has the cut-out when viewed from the above, is t2. Note that the cut-outs formed at the upper and lower corners on the left side when viewed from the front are not indispensable.

The opening section 12a is formed near the upper end on the front right side of the lens barrel 12b. In the lens barrel 12b, the imaging element 12c, the objective lens 12d, the prism 12e, the zoom lens group 12f, the focus lens 12g, the diaphragm and mechanical shutter 12h, the driving unit 12i, and the like, are arranged.

The imaging element 12c is configured by a color CCD (charge-coupled device) provided with R (red), G (green) and B (blue) color filters arranged in a predetermined color filter array (for example, a honeycomb array and a Bayer array), and is arranged on the bottom surface of the thick section as illustrated in FIG. 2A.

The objective lens 12d is arranged on the rear surface of the opening section 12a, and guides the light entering from the opening section 12a to the prism 12e.

The prism 12e substantially perpendicularly bends the optical path extending from the objective lens 12d, so as to guide the optical path to the zoom lens 12f and the focus lens 12g. The light guided to the zoom lens 12f and the focus lens 12g is imaged by the imaging element 12c.

The driving unit 12i is arranged in the thin section, and moves the zoom lens 12f between the tele-end and the wide-end in order to change the magnification of the optical system. Further, the driving unit 12i moves the focus lens 12g from the closest distance to the infinite distance in order to perform focus adjustment.

FIG. 3 is a perspective view of a major portion of the camera body 10 when viewed from the above, and illustrates the arrangement positions of the right lens unit 12 and the left lens unit 13 in the camera body 10.

The right lens unit 12 and the left lens unit 13 are arranged in the camera body 10 via a base 17. The right lens unit 12 is arranged adjacent to the right side surface of the camera body 10, while the left lens unit 13 is arranged adjacent to the left side surface of the camera body 10.

The base 17 is a plate-shaped member which is bent in a crank shape at the approximately center portion thereof, and is arranged on the front surface side in the camera body 10. The base 17 is fixed to the bottom surface or upper surface of the camera body 10. The base 17 is configured by attaching surfaces 17a and 17c and a positioning surface 17b. The right lens unit 12 is attached to the attaching surface 17a, while the left lens unit 13 is attached to the attaching surface 17c.

The attaching surface 17a and the front surface of the camera body 10 are in parallel with each other. The angle formed by the attaching surface 17a and the positioning surface 17b is about 90 degrees, while the angle formed by the positioning surface 17b and the attaching surface 17c is about (90 degrees—a convergence angle θ). That is, the attaching surface 17c is inclined inward (clockwise in the compound-eye digital camera 1 according to the present embodiment) by the convergence angle θ with respect to the front surface of the camera body 10.

The right lens unit 12 is fixed to the base 17 in such a manner that the front surface of the lens barrel 12b is brought into contact with the attaching surface 17a, and that the left side surface of the lens barrel 12b is brought into contact with the positioning surface 17b. Therefore, the front surface of the lens barrel 12b of the right lens unit 12 and the attaching surface 17a are in parallel with each other, and hence the right lens unit 12 and the camera body 10 are arranged in parallel with each other.

The left lens unit 13 is fixed to the base 17 so that the front surface of the thin section of the lens barrel 13b is brought into contact with the attaching surface 17c. Therefore, the front surface of the lens barrel 13b of the left lens unit 13 and the attaching surface 17c are in parallel with each other, and hence the left lens unit 13 is arranged so as to be inclined by the convergence angle θ with respect to the camera body.

Thereby, the right lens unit 12 and the left lens unit 13 can be arranged in the camera body 10 so that the angle formed by the optical axis L1 of the right lens unit 12 and the optical axis L2 of the left lens unit 13 becomes the convergence angle θ. Note that, in order to obtain a stereoscopic video image at a certain finite distance, the convergence angle θ is set so that the optical axes L1 and L2 cross each other about in the middle of the photographing distance range (between the infinite distance and the closest distance).

Further, when the left lens unit 13 whose thick section having the thickness t2 is positioned on the outer side is inclined inward by the convergence angle θ, and when the thin section is formed on the left side of the left lens unit 13, the thickness of the camera body can be reduced by (t1−t2)×cos θ, as compared with the case where the thin section is not formed on the left side of the left lens unit 13.

Note that the front surface of the lens barrel 13b is inclined by the convergence angle θ with respect to the front surface of the camera body 10, and hence a space is formed between the front surface of the lens barrel 13b and the front surface of the camera body 10. When the lens barrel 13b and the attaching surface 17c are attached to each other so as to allow an attaching member 18 for attaching the lens barrel 13b to the attaching surface 17c to be accommodated in the space, the space is effectively used, so that the thickness of the camera body 10 can be reduced.

The description is returned to FIG. 1. The flash 14 is configured by a xenon tube or an LED (light-emitting diode) and irradiates, as required, a subject with flash light in such a case as in the case of photographing a dark subject or of photographing under a back light condition.

The monitor 16 is a liquid crystal display monitor which has a common aspect ratio of 4:3 and which can perform color display. The monitor 16 can display both a stereoscopic image and a plane image. Although the detailed structure of the monitor 16 is not illustrated, the monitor 16 is a parallax barrier type 3D monitor on the surface of which a parallax barrier display layer is provided. The monitor 16 is used as a user interface display panel at the time of performing various setting operations, and is used as an electronic viewfinder at the time of photographing an image.

The monitor 16 can switch between the stereoscopic image display mode (3D mode) and the plane image display mode (2D mode). In the 3D mode, the monitor 16 generates, in its parallax barrier display layer, a parallax barrier formed of a pattern in which a light transmitting section and a light shielding section are alternately arranged side by side at a predetermined pitch. The monitor 16 also displays, in the image display surface under the parallax barrier display layer, strip-shaped image fragments respectively representing left and right images, by alternately arranging the strip-shaped image fragments. When the monitor 16 is used in the 2D mode or is used as the user interface display panel, the monitor displays nothing in the parallax barrier display layer, and displays one image as it is in the image display surface under the parallax barrier display layer.

Note that the monitor 16 is not limited to the parallax barrier type monitor, but a monitor, such as a lenticular type monitor, an integral photography type monitor which uses a microlens array sheet, and a holography type monitor which uses an interference phenomenon, may also be adopted. Further, the monitor 16 is not limited to the liquid crystal display monitor, but an organic EL monitor, and the like, may also be adopted.

The release switch 20 is configured by so-called a two-stage stroke-type switch which can be half-pressed and full-pressed. In the case where a still image is photographed (for example, in the case where the still image photographing mode is selected by the mode button 22, or where the still image photographing mode is selected from the menu), when the release switch 20 is half-pressed, the compound-eye digital camera 1 performs photographing preparation processing, that is, performs each of AE (Automatic Exposure) processing, AF (Auto Focus) processing, and AWB (Automatic White Balance) processing. Also, in the case of photographing the still image, when the release switch 20 is full-pressed, the compound-eye digital camera 1 performs image photographing and recording processing. Further, in the case where a moving image is photographed (for example, in the case where the moving image photographing mode is selected by the mode button 22, or where the moving image photographing mode is selected from the menu), when the release switch 20 is full-pressed, the compound-eye digital camera 1 starts photographing a moving image. Further, in the case of photographing the moving image, when the release switch 20 is again full-pressed, the compound-eye digital camera 1 ends the photographing operation.

The zoom button 21 is used for the zooming operation of the right lens unit 12 and the left lens unit 13, and is configured by a zoom tele button 21T for instructing a zooming operation to the telescopic side, and a zoom wide button 21W for instructing a zooming operation to the wide angle side.

The mode button 22 functions as a photographing mode setting device which sets the photographing mode of the compound-eye digital camera 1. The photographing mode of the compound-eye digital camera 1 is set to various modes according to the setting positions of the mode button 22. The photographing mode is divided into the “moving image photographing mode” which performs a moving image photographing operation, and the “still image photographing mode” which performs a still image photographing operation. The “still image photographing mode” includes such modes as for example, an “auto photographing mode” in which the diaphragm, the shutter speed, and the like, are automatically set by the compound-eye digital camera 1, a “face extraction photographing mode” in which the face of a person is extracted so as to be photographed, a “sports photographing mode” which is suitable for photographing a moving body, a “scenery photographing mode” which is suitable for photographing a scenery, a “night scene photographing mode” which is suitable for photographing an evening scene and a night scene, a “diaphragm priority photographing mode” in which the user sets the scale of the diaphragm and in which the compound-eye digital camera 1 automatically sets the shutter speed, a “shutter speed priority photographing mode” in which the user sets the shutter speed and in which the compound-eye digital camera 1 automatically sets the scale of the diaphragm, and a “manual photographing mode” in which the user sets the diaphragm, the shutter speed, and the like.

The parallax adjusting button 23 is a button which electronically adjusts the parallax at the time of photographing a stereoscopic image. When the upper side of the parallax adjusting button 23 is pressed, the parallax between the image photographed by the right lens unit 12 and the image photographed by the left lens unit 13 is increased by a predetermined distance. When the lower side of the parallax adjusting button 23 is pressed, the parallax between the image photographed by the right lens unit 12 and the image photographed by the left lens unit 13 is reduced by a predetermined distance.

The 2D/3D switching button 24 is a switch used to instruct the switching between the 2D photographing mode for photographing a single-viewpoint image, and the 3D photographing mode for photographing a multi-viewpoint image.

The MENU/OK button 25 is used to access various setting screens (menu screens) of the photographing and reproduction functions (MENU function). Also, the MENU/OK button 25 is used to instruct the determination of the selected contents and to instruct the execution of the processing of the selected contents (OK function). The setting of all the adjustment items provided for the compound-eye digital camera 1 is performed by using the MENU/OK button 25. When the MENU/OK button 25 is pressed at the time of photographing, a setting screen, which is used for image quality adjustments such as, for example, adjustment of an exposure value, hue, ISO sensitivity, the number of recording pixels, and the like, is displayed in the monitor 16. When the MENU/OK button 25 is pressed at the time of reproduction, a setting screen used for the image erasure, and the like, is displayed. The compound-eye digital camera 1 operates according to the conditions set on the menu screen.

The cross button 26 is a button used to perform the setting and selection of the various menu items or to perform the zooming operation, and is configured such that it can be pressed in the four directions (up/down/left/right directions) and such that the functions corresponding to the setting state of the camera are assigned to the buttons in the respective directions. For example, at the time of photographing, the function of switching ON/OFF of the macro function is assigned to the left button, and the function of switching the flash mode is assigned to the right button. Further, the function of switching the lightness of the monitor 16 is assigned to the upper button, and the function of switching ON/OFF and the time of the self-timer is assigned to the lower button. Further, at the time of reproduction, the frame feeding function is assigned to the right button, and the frame returning function is assigned to the left button. Further, the function of deleting the image under reproduction is assigned to the upper button. Further, during the various setting operations, the function of moving the cursor displayed on the monitor 16 in the direction of the each button is assigned to the each button.

The DISP/BACK button 27 functions as a button which instructs to switch the display of the monitor 16. When the DISP/BACK button 27 is pressed during photographing, the display of the monitor 16 is switched in the sequence of ON→the framing guide display→OFF. Further, when the DISP/BACK button 27 is pressed during reproduction, the display of the monitor is switched in the sequence of the normal reproduction→reproduction without characters→multi-reproduction. Further, the DISP/BACK button 27 functions as a button which instructs to cancel an input operation and to return the display to the display of the previous operation state.

FIG. 4 is a block diagram illustrating an internal configuration of a major portion of the compound-eye digital camera 1. The compound-eye digital camera 1 includes the CPU 110, an operation device (the release switch 20, the MENU/OK button 25, the cross button 26 grade) 112, an SDRAM (synchronous dynamic random access memory) 114, a VRAM (video random access memory) 116, an AF detection device 118, an AE/AWB detection device 120, timing generators (TG) 122 and 123, CDS/AMPs (Correlated Double Sampling/Amplifier) 124 and 125, A/D converters 126 and 127, an image input controller 128, an image signal processing device 130, a compression/expansion processing device 132, a video encoder 134, a media controller 136, a sound input processing section 138, a recording medium 140, a focus lens driving sections 142 and 143, zoom lens driving sections 144 and 145, and diaphragm driving sections 146 and 147.

The CPU 110 collectively controls the operation of the compound-eye digital camera 1 as a whole. The CPU 110 controls the operation of the right lens unit 12 and the left lens unit 13. The right lens unit 12 and the left lens unit 13 are operated fundamentally in linkage with each other, but can be operated separately from each other. Further, the CPU 110 forms the two image data obtained by the right lens unit 12 and the left lens unit 13 into strip-shaped image fragments, and generates display image data on the basis of which the strip-shaped image fragments are alternately displayed on the monitor 16. When performing a 3D mode display, the CPU 110 generates a parallax barrier formed of a pattern in which a light transmitting section and a light shielding section are alternately arranged at a predetermined pitch in the parallax barrier display layer, and also realizes a stereoscopic vision in such a manner that each of the strip-shaped image fragments representing the left image and each of the strip-shaped image fragments representing the right image are alternately arranged and displayed in the image display surface under the parallax barrier.

The SDRAM 114 or a ROM (not illustrated) stores firmware which is a control program that is executed by the CPU 110, various data necessary for the control, camera setting values, photographed image data, and the like.

The VRAM 116 is used as a work area of the CPU 110, and is also used as a temporary storage area of the image data.

According to a command from the CPU 110, the AF detection device 118 calculates, from the inputted image signals, physical quantities necessary for the AF control. The AF detection device 118 is configured by a right imaging system AF control circuit which performs the AF control on the basis of the image signal inputted from the right lens unit 12, and a left imaging system AF control circuit which performs the AF control on the basis of the image signal inputted from the left lens unit 13. In the compound-eye digital camera 1 according to the present embodiment, the AF control (so-called contrast AF) is performed on the basis of the contrast of the images obtained from the imaging elements 12c and 13c, and the AF detection device 118 calculates a focus evaluation value representing the sharpness of the image formed from the inputted image signals. The CPU 110 detects the position where the focus evaluation value calculated by the AF detection device 118 becomes a local maximum, and moves the focus lens group to the position. That is, the CPU 110 moves the focus lens group by a predetermined step from the closest distance to the infinite distance, so as to obtain a focus evaluation value at each position. Also, the CPU 110 sets, as the focusing position, the position where the obtained focus evaluation value becomes a maximum. Then, the CPU 110 moves the focus lens group to the focusing position.

According to a command from the CPU 110, the AE/AWB detection device 120 calculates, from the inputted image signals, physical quantities necessary for the AE control and the AWB control. For example, the AE/AWB detection device 120 divides one screen into a plurality of areas (for example 16×16 areas) and calculates, as physical quantities necessary for the AE control, integration values of the R, G, B image signals for each of the divided areas. The CPU 110 detects the lightness of the subject (subject luminance) on the basis of the integration values obtained from the AE/AWB detection device 120, and calculates an exposure value (photographing EV value) suitable for the photographing. Then, the CPU 110 determines a diaphragm value and a shutter speed on the basis of the calculated photographing EV value and a predetermined program diagram. Further, the AE/AWB detection device 120 divides one screen into a plurality of areas (for example 16×16 areas) and calculates, as physical quantities necessary for the AWB control, an average integration value of each of the R, G, B image signals for each of the divided areas. The CPU 110 obtains ratios of R/G and B/G for each of the divided areas from each of the obtained integration values of R, B and G, and determines the kind of light source on the basis of the distributions of the R/G value and the B/G value in the color space of R/G and B/G axis coordinates. Then, according to the white balance adjustment values suitable for the determined kind of light source, the CPU 110 determines gain values (white balance correction values) for the R, G and B signals in the white balance adjustment circuit so that each of the ratios becomes, for example, about 1 (that is, the R, G, B integration ratios of the one screen become 1:1:1).

The TGs 122 and 123 input the timing signals to the imaging elements 12c and 13c, respectively. The imaging elements 12c and 13c receive the subject light imaged by the focus lens group, the zoom lens group, and the like. The light made incident on the light receiving surface of the imaging elements 12c and 13c are converted into signal charges of an amount corresponding to the amount of the incident light by respective photodiodes arrayed on the light receiving surface. The photo charge accumulation and transfer operations of the imaging elements 12c and 13c are performed on the basis of the charge discharge pulses respectively inputted from the TGs 122 and 123, so that the electronic shutter speed (photo charge accumulation time) is determined.

That is, when the charge discharge pulses are inputted into the imaging elements 12c and 13c, the charges are discharged without being accumulated in the imaging elements 12c and 13c. On the other hand, when the charge discharge pulses are no longer inputted into the imaging elements 12c and 13c, the charges are prevented from being discharged, and hence the charge accumulation, that is, the exposure is started in the imaging elements 12c and 13c. The imaging signals acquired by the imaging elements 12c and 13c are outputted to the CDS/AMPs 124 and 125 on the basis of the driving pulses respectively inputted from the TGs 122 and 123.

The CDS/AMPs 124 and 125 perform correlated double sampling processing (in which, in order to reduce the noise (especially thermal noise), and the like, included in the output signal of the imaging element, accurate pixel data are obtained by taking a difference between the levels of the field through component and the pixel signal component which are included in the output signal of each pixel of the imaging element) to the image signals outputted from the imaging elements 12c and 13c, and generates R, G, B analog image signals by amplifying the image signals subjected to the correlated double sampling processing.

The A/D converters 126 and 127 convert the R, G, B analog image signals generated by the CDS/AMPs 124 and 125 into digital image signals.

The image input controller 128, in which a line buffer having a predetermined capacity is incorporated, accumulates, according to a command from the CPU 110, the image signals of one image outputted from the CDS/AMPs and the AD converter, and then stores the accumulated image signal in the VRAM 116.

The image signal processing device 130, which includes a synchronization circuit (processing circuit which interpolates spatial deviations of the color signals due to the color filter array of the single plate CCD to simultaneously convert the color signals), a white balance correction circuit, a gamma correction circuit, a contour correction circuit, a luminance and color difference signal generation circuit, and the like, applies, according to a command from the CPU 110, required processing to the inputted image signals, so as to generate image data (YUV data) formed of luminance data (Y data) and color difference data (Cr and Cb data).

The compression/expansion processing device 132 applies, according to a command from the CPU 110, compression processing based on a predetermined format to the inputted image data, so as to generate compressed image data. Further, according to a command from the CPU 110, the compression/expansion processing device 132 applies expansion processing based on the predetermined format to the inputted compressed image data, so as to generate non-compressed image data.

The video encoder 134 controls the display on the monitor 16. That is, the video encoder 134 converts video signals stored in the recording medium 140, and the like, into video signals (for example, NTSC (National Television System Committee) signals, PAL (Phase Alternating Line) signals, SECAM (Sequential Color with Memory) signals) for display on the monitor 16, and also outputs, as required, predetermined characters and graphic information to the monitor 16.

The media controller 136 records, in the recording medium 140, each of the image data subjected to the compression processing by the compression/expansion processing device 132.

The sound input processing section 138 receives sound signals, which are inputted into the microphone 15 and amplified by a stereo microphone amplifier (not illustrated), and performs encoding processing of the sound signals.

As the recording medium 140, various recording media are used, which include semiconductor memory cards that can be detachably attached to the compound-eye digital camera 1 and that are represented by an xD picture card (registered trademark) as well as by a SmartMedia (registered trademark), a portable type small hard disk, a magnetic disk, an optical disk, a magneto-optical disk, and the like.

The focus lens driving sections 142 and 143 respectively move, according to a command from the CPU 110, the focus lenses 12g and 13g in the optical axis direction, so as to change the focus position.

The zoom lens driving sections 144 and 145 respectively move, according to a command from the CPU 110, the zoom lens 12f and 13f in the optical axis direction, so as to change the focal distance.

The diaphragm and mechanical shutters 12h and 13h are respectively driven by the iris motors of the diaphragm driving sections 146 and 147, and thereby change the opening amount thereof, so as to adjust the amount of light made incident on the imaging elements 12c and 13c.

The diaphragm driving sections 146 and 147 respectively change, according to a command from the CPU 110, the opening amount of the diaphragm and mechanical shutters 12h and 13h, so as to adjust the amount of light made incident on the imaging elements 12c and 13c. Further, the diaphragm driving sections 146 and 147 respectively open and close, according to a command from the CPU 110, the diaphragm and mechanical shutters 12h and 13h, so as to respectively perform the exposure and light shielding operations to the imaging elements 12c and 13c.

The effects of the compound-eye digital camera 1 configured as described above will be described. When the barrier 11 is slid from the closed state to the opened state, the power source of the compound-eye digital camera 1 is turned on, so that the compound-eye digital camera 1 starts to operate under the photographing mode. As the photographing modes, it is possible to set the 2D photographing mode and the 3D photographing mode for photographing a stereoscopic image of a subject viewed from two viewpoints. The photographing mode can be set from the menu screen which is displayed on the monitor at the time when the MENU/OK button 25 is pressed while the compound-eye digital camera 1 is driven under the photographing mode.

(1) 2D Photographing Mode

The CPU 110 selects the right lens unit 12. In the right lens unit 12, the front surface of the lens barrel 12b is arranged in parallel with the front surface of the camera body 10 similarly to the common single-eye digital camera. Therefore, in the case of the 2D photographing mode, the photographer can photograph a plane image by using the right lens unit 12 without feeling a sense of incongruity.

First, the CPU 110 starts photographing live view images by using the imaging element 12c. That is, images are continuously photographed by the imaging element 12c. The obtained image signals are continuously processed, so that live view image data are generated.

The CPU 110 sets the monitor 16 to the 2D mode. Then, the CPU 110 successively inputs the generated image data to the video encoder 134 which converts the inputted image data into image data based on a display signal format and which outputs the converted image data to the monitor 16. Thereby, the image captured by the imaging element 12c is through-displayed on the monitor 16. In the case where the input of the monitor 16 corresponds to the digital signal, the video encoder 134 is not necessary, but the image signal needs to be converted into a signal form matching with the input specification of the monitor 16.

While viewing the through image displayed on the monitor 16, the user performs such operations as framing, confirmation of the subject desired to be photographed, confirmation of a photographed image, and setting of photographing conditions.

When the release switch 20 is half-pressed in the above described photographing standby state, an S1ON signal is inputted to the CPU 110. The CPU 110 detects the inputted signal and performs the AE photometry and the AF control. When performing the AE photometry, the CPU 110 measures the lightness of the subject on the basis of an accumulation value, and the like, of image signals captured via the imaging element 12c. The measured value (photometric value) is used to determine the diaphragm value and the shutter speed of the diaphragm and mechanical shutter 12h at the time of actual photographing. At the same time, on the basis of the detected subject luminance, the CPU 110 determines whether or not the flash 14 needs to be flashed. When determining that the flash needs to be flashed, the CPU 110 preliminarily flashes the flash 14. Then, on the basis of the reflected preliminary flash light, the CPU 110 determines the flash light amount of the flash 14 at the time of actual photographing.

When the release switch 20 is full-pressed, an S2ON signal is inputted into the CPU 110. In response to the S2ON signal, the CPU 110 performs the photographing and recording processing.

First, the CPU 110 drives the diaphragm and mechanical shutter 12h via the diaphragm driving section 147 on the basis of the diaphragm value determined on the basis of the photometric value. Also, the CPU 110 controls the charge accumulation time (so-called electronic shutter) in the imaging element 12c so as to correspond to the shutter speed determined on the basis of the photometric value.

Further, when performing the AF control, the CPU 110 performs contrast AF in which, while the focus lens is successively moved from the closest lens position to the lens position corresponding to the infinite distance via the focus lens driving section 142, an evaluation value, obtained by integrating the high frequency components of the image signal in the AF area of the image captured for each lens position via the imaging elements 12c, is acquired from the AF detection device 118, in which the lens position where the evaluation value becomes a peak is obtained, and in which the focus lens is then moved to the lens position.

In this case, when the flash 14 is to be flashed, the flash 14 is made to flash on the basis of the flash light amount which is obtained from the result of the preliminary flash of the flash 14.

The subject light is made incident on the light receiving surface of the imaging element 12c via the focus lens 12g, the zoom lens 12f, the diaphragm and mechanical shutter 12h, an infrared ray cut filter 46, an optical low pass filter 48, and the like.

The signal charges accumulated in each photodiode of the imaging element 12c are read according to the timing signal inputted from the TG 122, and are successively outputted as voltage signals (image signals) from the imaging element 12c, so as to be inputted into the CDS/AMP 124.

The CDS/AMP 124 applies the correlated double sampling processing to the CCD output signal on the basis of the CDS pulse, and amplifies the image signal outputted from the CDS circuit, on the basis of the photography sensitivity setting gain inputted from the CPU 110.

The analog image signals outputted from the CDS/AMP 124 is converted into digital image signals in the A/D converter 126. The converted image signals (R, G, B RAW data) are transferred to the SDRAM 114, and are once stored in the SDRAM 114.

The R, G, B image signals read from the SDRAM 114 are inputted into the image signal processing device 130. In the image signal processing device 130, white balance adjustment processing is performed in the white balance adjusting circuit by applying the digital gain processing to each of the R, G, B image signals, and also the gradation conversion processing according to the gamma characteristics of the image signals is performed by the gamma correction circuit. Further, the synchronization processing, which matches the phases of the color signals with each other by interpolating the spatial deviations between the respective color signals due to the color filter array of the single plate CCD, is performed in the image signal processing device 130. The synchronized R, G, B image signals are converted into the luminance signal Y and the color difference signals Cr and Cb (YC signals) by the luminance and color difference data generation circuit. The Y signal is subjected to contour emphasis processing by the contour correction circuit. The YC signals processed by the image signal processing device 130 are again stored in the SDRAM 114.

The YC signals stored in the SDRAM 114 as described above are compressed by the compression/expansion processing device 132, so as to be recorded, as an image file based on a predetermined format, in the recording medium 140 via the media controller 136. The still image data are stored, as an image file based on the Exif standard, in the recording medium 140. The Exif file has a region for storing the main image data, and a region for storing the minified image (thumbnail image) data. The thumbnail image of a prescribed size (for example, 160×120 pixels, 80×60 pixels, or the like) is generated, through the necessary processing, such as the pixel thinning processing, from the main image data acquired by the photographing. The thumbnail image generated in this way is written in the Exif file together with the main image. Further, tag information, such as the photographing date, the photographing conditions, the face detection information, and the like, are attached to the Exif file.

(2) 3D Photographing Mode

The live view image photographing is started by using the imaging element 12c and the imaging element 13c. That is, the same subject is continuously imaged by using the imaging element 12c and the imaging element 13c, and the image signals of the subject are continuously processed, so that live view stereoscopic image data are generated. The CPU 110 sets the monitor 16 to the 3D mode. The generated image data are successively converted by the video encoder 134 into the data based on the display signal format, and are then outputted to the monitor 16, respectively.

The generated image data are successively inputted into the video encoder 134, and are then converted into the data based on the display signal format, so as to be outputted to the monitor 16. Thereby, the live view stereoscopic image data are through-displayed on the monitor 16.

While viewing the through image displayed on the monitor 16, the user performs such operations as framing, confirmation of the subject desired to be photographed, confirmation of a photographed image, and setting of photographing conditions.

When the release switch 20 is half-pressed in the above described photographing standby state, the S1ON signal is inputted into the CPU 110. The CPU 110 detects the S1ON signal and performs the AE photometry and the AF control. The AE photometry is performed by one of the right lens unit 12 and the left lens unit 13 (by the left lens unit 13 in the present embodiment). Further, the AF control is performed by each of the right lens unit 12 and the left lens unit 13. The AE photometry and the AF control are usually the same as those in the 2D photographing mode, and hence the detailed description thereof will be omitted.

When the release switch 20 is full-pressed, the S2ON signal is inputted into the CPU 110. In response to the S2ON signal, the CPU 110 performs the photographing and recording processing. The processing for generating the image data photographed by each of the right lens unit 12 and the left lens unit 13 is the same as the processing in the normal 2D photographing mode, and hence the description thereof will be omitted.

From the two sets of image data respectively generated by the CDS/AMPs 124 and 125, two sets of compressed image data are generated by the same method as that in the 2D photographing mode. The two sets of compressed image data are recorded in a recording medium 140 so as to be related with each other.

When a signal to switch from the 3D photographing mode to the other photographing mode is inputted, since the photographing mode of the transition destination is usually the 2D photographing mode, the CPU 110 switches the monitor 16 to the 2D mode, and starts the processing of the other photographing mode.

When the mode of the compound-eye digital camera 1 is set to the reproduction mode, the CPU 110 outputs a command to the media controller 136, so as to make the media controller 136 read the image file finally recorded in the recording medium 140.

The compressed image data of the read image file are inputted into the compression/expansion processing device 132, so as to be expanded into non-compressed luminance and color difference signals. The expanded signals are formed into stereoscopic image data by the CPU 110, and are then outputted to the monitor 16 via the video encoder 134. Thereby, the image recorded in the recording medium 140 is reproduced and displayed in the monitor 16 (reproduction of one image).

In the reproduction of one image, the image photographed in the 2D photographing mode is usually displayed in the 2D mode on the whole screen of the monitor 16, while the image photographed in the 3D mode is usually displayed in the 3D mode on the whole screen of the monitor 16.

The frame feeding of the images is performed by an operation of the right and left keys of the cross button 26. When the right key of the cross button 26 is pressed, the next image file is read from the recording medium 140, so as to be reproduced and displayed in the monitor 16. When the left key of the cross button is pressed, the previous image file is read from the recording medium 140, so as to be reproduced and displayed in the monitor 16.

It is possible to erase, as required, the image recorded in the recording medium 140, while confirming the image reproduced and displayed in the monitor 16. The erasure of the image is performed by pressing the MENU/OK button 25 in the state where the image is reproduced and displayed in the monitor 16.

According to the present embodiment, the camera body can be made thin in such a manner that the left lens unit, the thick section of which has the thickness t2 and is positioned on the outer side, is inclined inward by the convergence θ, and that the thin section is formed on the left side (when viewed from the front of the camera body 10) of the left lens unit. Further, the camera body 10 can be made thin by effectively using the space formed between the left lens unit and the front surface of the camera body.

Note that in the present embodiment, the base 17 is arranged on the rear side of the front surface of the camera body 10, and the front surfaces of the lens barrels 12b and 13b are attached to the base 17, whereby the right lens unit 12 and the left lens unit 13 are arranged in the camera body 10 so as to make the optical axis L1 of the right lens unit 12 and the optical axis L2 of the left lens unit 13 cross each other at the convergence angle θ. However, the method, by which the right lens unit 12 and the left lens unit 13 are arranged in the camera body 10 so as to make the optical axis L1 of the right lens unit 12 and the optical axis L2 of the left lens unit 13 cross each other at the convergence angle θ, is not limited to this.

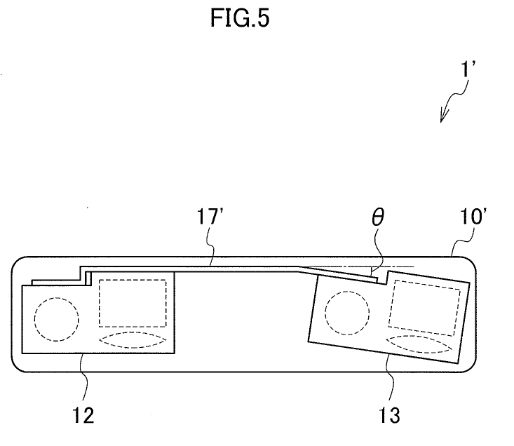

FIG. 5 illustrates a compound-eye digital camera l′ which is a modification of the first embodiment. A base 17′ is arranged on the inner side of the rear surface of a camera body 10′. The left end of the base 17′ is bent by a convergence angle θ to the front side, and this bent portion is brought into contact with the rear surface of the thin section of the lens barrel 13b of the left lens unit 13, so as to be fixed to the rear surface of the thin section by an attaching member (not illustrated).

The right end of the base 17′ is bent in a crank shape, and the distal end section bent in the crank shape is brought into contact with the rear surface of the thin section of the lens barrel 12b of the right lens unit 12, so as to be fixed to the rear surface of the thin section by an attaching member (not illustrated).

Thereby, it is possible to attach the base 17′ to the right lens unit 12 as well as to the left lens unit 13 by effectively utilizing the space formed between the rear surface of the camera body 10′ and the right and left lens units 12 and 13. Therefore, the thickness of the camera body 10′ can be reduced.

Further, in the present embodiment, the base 17 is fixed to the bottom surface or the upper surface of the camera body 10. However, the base 17 and the camera body 10 may be integrally formed. Further, in the present embodiment, the thick section is formed on the right side of the right lens unit 12 and the left lens unit 13 when viewed from the front of the right lens unit 12 and the left lens unit 13, and the left lens unit 13 is inclined inward by the convergence angle θ. However, it may also be configured such that the thick section is formed on the left side of the right lens unit 12 and the left lens unit 13 when viewed from the front of the right lens unit 12 and the left lens unit 13, and that the right lens unit 13 is inclined inward by the convergence angle θ.

Further, in the present embodiment, the bending optical system is used for the lens units (the right lens unit 12 and the left lens unit 13). However, the optical system used for the lens units is not limited to the bending optical system, and a collapsible optical system may also be used. However, when the bending optical system is used, the thickness of the lens unit, that is, the thickness of the compound-eye digital camera can be more reduced.

### Second Embodiment

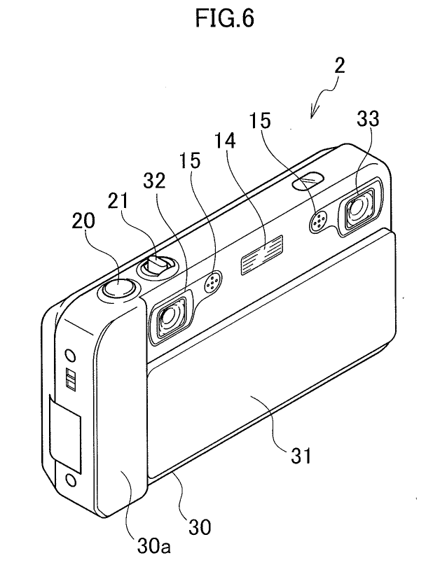

FIG. 6 is a front perspective view of a compound-eye digital camera 2 which is a stereoscopic imaging apparatus according to a second embodiment of the presently disclosed subject matter. The same portions as those of the compound-eye digital camera 1 according to the first embodiment are denoted by the same reference numerals and characters, and the explanation thereof is omitted. Further, the effect of the compound-eye digital camera 2 is the same as that of the compound-eye digital camera 1, and hence the explanation thereof is omitted.

A camera body 30 of the compound-eye digital camera 2 is formed in a substantially rectangular parallelepiped box shape, and a projecting section 30a having the same height as the thickness of a barrier 31 is formed at the right end of the front surface of the camera body 30. As illustrated in FIG. 6, the barrier 31, a right lens unit 32, a left lens unit 33, the flash 14, and the microphones 15 are mainly provided on the front surface of the camera body 30. Further, the release switch 20 and the zoom button 21 are mainly provided on the upper surface of the camera body 30.

On the other hand, the monitor 16, the mode button 22, the parallax adjusting button 23, the 2D/3D switching button 24, the MENU/OK button 25, the cross button 26, and the DISP/BACK button 27 are provided on the rear face of the camera body 30.

The barrier 31 is slidably mounted in the portion of the front surface of the camera body in which portion the projecting section 30a is not formed, that is, is slidably mounted so as to avoid the projecting section 30a. The opened state and the closed state of the camera body are switched from each other by vertically sliding the barrier 31. The barrier 31 is usually positioned at the upper end, that is, held in the closed state, so that the right lens unit 32 and the left lens unit 33, and the like, are covered by the barrier 31. Thereby, the lenses, and the like, can be prevented from being damaged. When the barrier 31 is slid so as to be positioned at the lower end, that is, held in the opened state (see FIG. 6), the lenses, and the like, provided on the front surface of the camera body 30 are exposed. When it is recognized by a sensor (not illustrated) that the barrier 31 is held in the opened state, the power source is turned on by a CPU 330 (see FIG. 4), so that the photographing operation is enabled.

The right lens unit 32 for photographing the right eye image is an optical unit including the opening section 12a, a lens barrel 32b, the imaging element 12c, the objective lens 12d, a photographing lens group (a prism 32e, the zoom lens 12f, the focus lens 12g) having a bending optical system, the diaphragm and mechanical shutter 12h, and the driving unit 12i. The left lens unit 33 for photographing the left eye image is an optical unit including the opening section 13a, a lens barrel 33b, the imaging element 13c, the objective lens 13d, a photographing lens group (a prism 33e, the zoom lens 13f, the focus lens 13g, and the like) having a bending optical system, the diaphragm and mechanical shutter 13h, and the driving unit 13i. The right lens unit 32 and the left lens unit 33 have the same configuration, and hence, in the following, the right lens unit 32 will be described as an example.

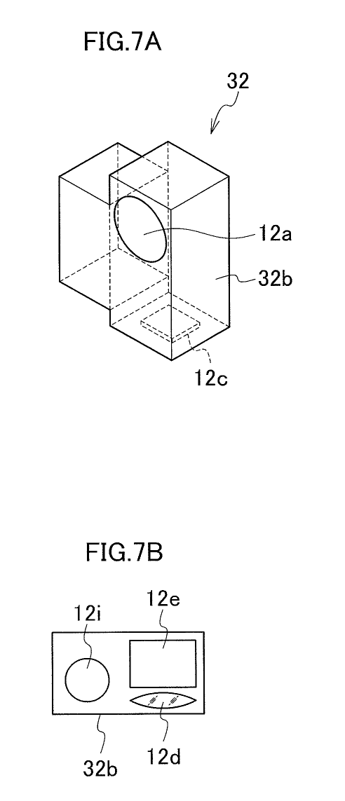

FIG. 7A is a front perspective view of the right lens unit 32, and FIG. 7B is a perspective view of a major portion of the right lens unit 32 when viewed from the above.

The lens barrel 32b, which is a substantially rectangular shaped frame when viewed from the front and above, has, as illustrated in FIG. 7A, cut-outs at the upper and lower corners on the left side when viewed from the front. The opening section 12a is formed near the upper end on the front right side of the lens barrel 32b. Note that the cut-outs formed at the upper and lower corners on the left side when viewed from the front are not indispensable.

In the lens barrel 32b, the imaging element 12c, the objective lens 12d, the prism 12e, the zoom lens 12f, the focus lens 12g, the diaphragm and mechanical shutter 12h, the driving unit 12i, and the like, are arranged (See FIG. 4).

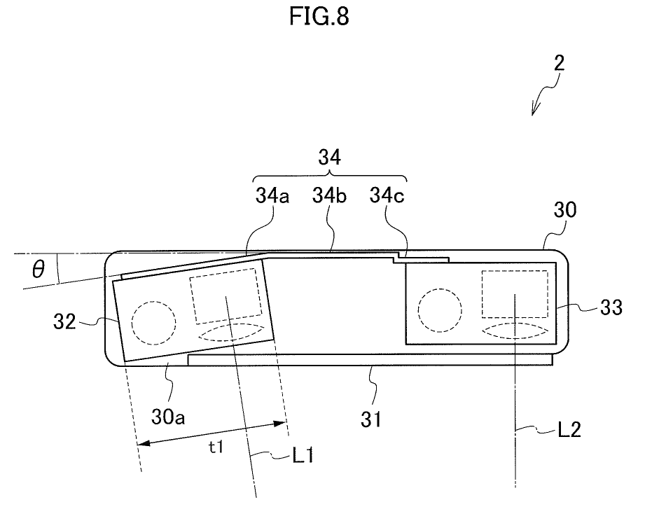

FIG. 8 is a perspective view of a major portion of the camera body 30 when viewed from the above, and illustrates the arrangement positions of the right lens unit 12 and the left lens unit 13 in the camera body 30.

The right lens unit 32 and the left lens unit 33 are arranged side by side in the left and right direction in the camera body 30 via a base 34. The right lens unit 32 is arranged adjacent to the right side surface of the camera body 30, while the left lens unit 33 is arranged adjacent to the left side surface of the camera body 30.

The base 34 is a plate-shaped member configured by a main body section 34b and attaching surfaces 34a and 34c, and is arranged on the rear surface side in the camera body 30. The right lens unit 32 is attached to the attaching surface 34a, while the left lens unit 33 is attached to the attaching surface 34c.

The attaching surface 34a is positioned on the right side of the main body section 34b, and the angle formed by the attaching surface 34a and the main body section 34b is almost equal to the convergence angle θ. The attaching surface 34c is positioned on the left side of the main body section 34b with the crank shape as a boundary, and the main body section 34b is in parallel with the attaching surface 34c. That is, the attaching surface 34a is inclined inward (counter clockwise in the compound-eye digital camera 2 according to the present embodiment) by the convergence angle θ with respect to the camera body 30, and the attaching surface 34c is in parallel with the front surface of the camera body 30.

The right lens unit 32 is fixed to the base 34 so that the rear surface of the lens barrel 32b is brought into contact with the attaching surface 34a. Therefore, the right lens unit 32 is arranged so that the rear surface of the lens barrel 32b is in parallel with the attaching surface 34a, that is, the right lens unit 32 is arranged so as to be inclined by the convergence angle θ with respect to the camera body 30.

The right lens unit 32 is arranged so as to be inclined inward by the convergence angle θ. However, since the projecting section 30a is formed, the space formed by the projecting section 30a can be effectively used. That is, the right lens unit 32 is arranged so as to be inclined with respect to the camera body 30, and hence a larger thickness of the camera body 30 is required for the right lens unit 32 as compared with the thickness required for the left lens unit 33 arranged in parallel with the camera body 30. However, the increase in the thickness is absorbed by the projecting section 30a, so that the thickness of the camera body 30 as whole can be reduced. For example, when the size of the right lens unit 32 is set as t1, and when it is assumed that about half of the right lens unit 32 is arranged in the space formed by the projecting section 30a, it is possible to reduce the thickness of the camera body 30 by (t1/2)×sin θ as compared with the case where the projecting section 30a is not formed.

The left lens unit 33 is fixed to the base 34 so that the rear surface of the lens barrel 33b is brought into contact with the attaching surface 34c. Therefore, in the left lens unit 33, the rear surface of the lens barrel 33b and the attaching surface 34b are in parallel with each other, that is, the left lens unit 33 is arranged in parallel with the camera body 30.

Thereby, the right lens unit 32 and the left lens unit 33 can be arranged in the camera body 30 so that the optical axis L1 of the right lens unit 32 and the optical axis L2 of the left lens unit 33 cross each other at the convergence angle θ.

According to the present embodiment, since the right lens unit is arranged by effectively utilizing the space formed by the projecting section 30a, and since the barrier is arranged in the portion in which the projecting section is not formed, it is possible to reduce the thickness of the camera body 30.

Note that in the present embodiment, the projecting section 30a is formed at the right end of the front surface of the camera body 30, and the right lens unit 32 is arranged so as to be inclined inward by the convergence angle θ. However, it may also be configured such that a projecting section is formed at the left end of the front surface of the camera body, and such that the left lens unit 32 is arranged so as to be inclined inward by the convergence angle θ. Further, the camera is also configured such that projecting sections are formed at the left and the right end of the front surface of the camera body, and such that the left lens unit and the right lens unit are arranged so as to be inclined inward by the convergence angle (θ/2), respectively. Further, in the present embodiment, the height of the projecting section 30a is set to be approximately equal to the thickness of the barrier 31, but the height of the projecting section 30a need not be approximately equal to the thickness of the barrier 31. However, when the height of the projecting section 30a is set to be approximately equal to the thickness of the barrier 31, it is possible to more effectively utilize the inner space of the camera body 30.

Note that the application of the presently disclosed subject matter is not limited to the compound-eye digital camera having two imaging units. The presently disclosed subject matter may also be applied to a compound-eye digital camera having three or more imaging systems. In the case of the compound-eye digital camera having three or more imaging systems, at least one imaging system may be arranged so as to be inclined inward by the convergence angle θ.

What is claimed is:

1. A stereoscopic imaging apparatus comprising:
a first and second imaging units, each of which has a substantially rectangular shape when viewed from above, and each of which has a thick section and a thin section that are arranged side by side; and
a camera body which has a substantially rectangular shape when viewed from above, and in which the first and second imaging units are arranged side by side in a lateral direction of the camera body,
wherein the first and second imaging units are arranged in the camera body so that the thin section of the first imaging unit is positioned at an outer side of the camera body and so that the thick section of the second imaging unit is positioned at the outer side of the camera body,
wherein the first imaging unit is arranged in parallel with the lateral direction of the camera body, and
wherein the second imaging unit is arranged so as to be inclined inward by a predetermined angle with respect to the lateral direction of the camera body.

2. The stereoscopic imaging apparatus according to claim 1, further comprising:
a connecting member which connects the first and second imaging units to each other; and
an attaching member which attaches the second imaging unit to the connecting member,
wherein the attaching member is arranged in a space formed between the second imaging unit and the camera body.

3. The stereoscopic imaging apparatus according to claim 2, wherein
the second imaging unit is arranged in a space formed between the front surface of the second imaging unit and the camera body.

4. The stereoscopic imaging apparatus according to claim 2, wherein
the second imaging unit is arranged in a space formed between the rear surface of the thin section of the second imaging unit and the rear surface of the camera body.

5. A stereoscopic imaging apparatus comprising:
a first and second imaging units, each of which has a substantially rectangular shape when viewed from above;
a camera body, on a front surface of which a projecting section is formed, which has a substantially rectangular shape when viewed from above, and in which the first and second imaging units are arranged side by side in a lateral direction of the camera body; and
a barrier which is arranged on the front surface of the camera body so as to avoid the projecting section,
wherein the first imaging unit is arranged in parallel with the lateral direction of the camera body, and
wherein the second imaging unit is arranged on a rear surface of the projecting section so as to be inclined inward by a predetermined angle with respect to the lateral direction of the camera body.

6. The stereoscopic imaging apparatus according to claim 5, wherein
the projecting section has a height substantially equal to the thickness of the barrier.

7. The stereoscopic imaging apparatus according to claim 1, wherein
the first and second imaging unit each comprises:
an imaging element provided on a bottom surface thereof;
an opening section formed in the front surface thereof; and
a bending optical system which bends subject light entering from the opening section to form an image of the subject light thereon.

8. The stereoscopic imaging apparatus according to claim 5, wherein
the first and second imaging unit each comprises:
an imaging element provided on a bottom surface thereof;
an opening section formed in the front surface thereof; and
a bending optical system which bends subject light entering from the opening section to form an image of the subject light thereon.

9. The stereoscopic imaging apparatus according to claim 1, further comprising:
a photographing mode switching device which switches between a stereoscopic image photographing mode for photographing a stereoscopic image by using both the first and second imaging units and a plane image photographing mode for photographing a plane image by using one of the first and second imaging units; and
a control device which, when the photographing mode is switched to the plane image photographing mode, performs a photographing operation by using the first imaging unit.

10. The stereoscopic imaging apparatus according to claim 5, further comprising:
a photographing mode switching device which switches between a stereoscopic image photographing mode for photographing a stereoscopic image by using both the first and second imaging units and a plane image photographing mode for photographing a plane image by using one of the first and second imaging units; and
a control device which, when the photographing mode is switched to the plane image photographing mode, performs a photographing operation by using the first imaging unit.
